(19) United States
(12) Patent Application Publication
(10) Pub. No.: US 2024/0069331 A1
(43) Pub. Date: Feb. 29, 2024

(54) METHOD FOR DESIGNING MIRROR AND ASTIGMATISM CONTROL MIRROR HAVING REFLECTING SURFACE SATISFYING DESIGN FORMULA IN SAID DESIGNING METHOD

(71) Applicant: The University of Tokyo, Tokyo (JP)

(72) Inventors: Yoko TAKEO, Tokyo (JP); Hidekazu MIMURA, Tokyo (JP)

(73) Assignee: The University of Tokyo, Tokyo (JP)

(21) Appl. No.: 18/271,833

(22) PCT Filed: Jan. 11, 2022
(86) PCT No.: PCT/JP2022/000568

§ 371 Date: Jul. 11, 2023

(30) Foreign Application Priority Data
Jan. 12, 2021 (JP) 2021-003118

(51) Int. Cl. G02B 27/00; G02B 5/10

(52) U.S. Cl. CPC G02B 27/0012; G02B 5/10; G02B 27/0025

(57) ABSTRACT

In a method for designing a mirror when any point on a reflecting surface is represented by M, coordinates of an intersection point between a sagittal light source ray and an incoming light ray to the M point and an intersection point between a meridional light source ray and the incoming light ray to the M point are expressed by using L₁ₛ and L₁ₘ, and coordinates of an intersection point between an outgoing light ray from the M point and a sagittal collected light ray and an intersection point between the outgoing light ray from the M point and a meridional collected light ray are expressed by using L₂ₛ and L₂ₘ. A mirror is designed using design formulas of a reflecting surface derived based on the coordinates and a condition that an optical path length from a light source position to a light collection position is constant with respect to any point on the reflecting surface for both the light collection in the sagittal direction and the light collection in the meridional direction.

### TECHNICAL FIELD

The present invention relates to a method for designing a mirror manufactured by forming a reflecting surface on a plate surface and an astigmatism control mirror having a reflecting surface satisfying a design formula provided in the method for designing a mirror.

### BACKGROUND ART

A soft X-ray beam of emitted light is characterized in that characteristics thereof are different between a vertical direction and a horizontal direction. A beam size tends to be smaller in the vertical direction than in the horizontal direction. A coherent width is larger in the vertical direction than in the horizontal direction. Moreover, in a spectroscopic system using a diffraction grating which is widely used for a soft X-ray beamline, a divergence angle of a beam in the vertical direction increases. In addition, since a spectroscope including the diffraction grating to be used collects soft X-rays only in a spectral direction, “astigmatism” occurs in which light source positions are different between the spectral direction and a direction in which the soft X-rays are not collected.

As a method of an optical system that handles such beams having different characteristics in the vertical direction and the horizontal direction, for example, a method of using a two-stage light collection optical system including two mirrors arranged to handle each of the vertical direction and the horizontal direction, setting light source points independently in the vertical direction and the horizontal direction, and matching light collection points has been conventionally used. Specifically, a method of arranging two elliptical cylinder mirrors vertically and horizontally, a method of establishing an approximate shape by arranging two bent mirrors (mechanically bent cylinder mirrors), a method of arranging two mirrors of a bent mirror and a sagittal cylinder mirror to face each other in the horizontal direction, and the like are known. However, the case of the method of combining two mirrors as described above results in a complicated mechanism and an increase in size of a chamber, and thus costs increase. and adjustment becomes difficult.

A toroidal mirror has a possibility of eliminating astigmatism with a single mirror (Non Patent Literature 1). However, a toroidal mirror is a mirror that is easily manufactured by approximating an existing spheroidal mirror and setting a uniform radius of curvature in each of a longitudinal direction and a transverse direction of a reflecting surface, and has a disadvantage in that a light collection size increases in principle even if astigmatism can be eliminated.

An astigmatic off-axis mirror (AO mirror) has also been proposed as a mirror capable of making a light collection size smaller than that of the toroidal mirror and capable of setting light source and light collection points independently in the vertical and horizontal directions (Non Patent Literature 2). This mirror has a shape in which different conic curves are set in a longitudinal direction and a transverse direction and a curved surface smoothly connecting the conic curves is obtained on the basis of: a principle that an elliptic curve is applied as a ridgeline of the reflecting surface to collect beams diverging from one point, at another point; a parabola is applied as a ridgeline of the reflecting surface to collimate beams diverging from one point; and a hyperbola is applied as a ridgeline of the reflecting surface to convert beams collected toward one point into beams collected toward another point.

However, this AO mirror is a mirror defined by rotating a conic curve profile in the longitudinal direction around a straight line (long axis) connecting focal points of conic curves in the transverse direction in order to obtain a curved surface. Since the reflecting surface approximates an axisymmetric shape, there is a limit in reducing a light collection size due to the approximation. No problem arises as long as a beam is a beam in a terahertz region with a long wavelength, but the AO mirror cannot cope with a beam in an X-ray region. In addition, a design formula includes coordinate transformation several times, which is very complicated, and parameters are also complicated and difficult to understand and use.

### CITATIONS LIST

### Non Patent Literature

Non Patent Literature 1: William A. Rense, T. Violett, “Method of Increasing the Speed of a Grazing-Incidence Spectrograph”, JOURNAL OF THE OPTICAL SOCIETY OF AMERICA, Vol. 49, No. 2, February 1959, p. 139 to p. 141
Non Patent Literature 2: A. Wagner-Gentner, U. U. Graf, M. Philipp, D. Rabanus, “A simple method to design astigmatic off-axis mirrors” Infrared Physics & Technology 50, 2007, p. 42 to p. 46

### SUMMARY OF INVENTION

### Technical Problems

In this respect, in view of the above-described situation, an object of the present invention is to provide a method for designing a mirror, by which a single mirror can be manufactured, the single mirror: enabling free conversion of astigmatism by enabling a light source position and a light collection position to be set independently in a vertical direction and a horizontal direction; enabling a light collection size to be further reduced to cope with a beam in an X-ray region; and being suitably used as an optical system that has a wide application range with a simple design formula and handles a beam having different characteristics between the vertical direction and the horizontal direction.

### Solutions to Problems

As a result of intensive studies in view of such a current situation, the present inventors have completed the present invention by finding that, as a method for geometrically and optically expressing properties of a beam having astigmatism, it is possible to provide a method for designing a mirror which can solve the problem described above by: newly defining a “light source ray” and a “collected light ray” for each of light collection in a sagittal direction and light collection in a meridional direction; assuming that all incoming light rays passing through a reflecting surface of the mirror pass through each of “light source rays” in a vertical direction and a horizontal direction and all outgoing light rays emitted from the reflecting surface of the mirror pass through “collected light rays” in the vertical direction and the horizontal direction; and applying Fermat's principle in which an “optical path length” from a light source position to a light collection position is constant.

That is, the present invention includes the following inventions.

(1) A method for designing a mirror manufactured by forming a reflecting surface on a plate surface, the method including: defining an optical axis of an incoming beam to the mirror as a z₁ axis, and defining a cross section orthogonal to the z₁ axis as an x₁y₁ plane; defining an optical axis of an outgoing beam from the mirror as a z₂ axis. and defining a cross section orthogonal to the z₂ axis as an x₁y₂ plane; setting the x₁ axis and the x₂ axis to be parallel to a sagittal direction of the reflecting surface; causing incoming beams to have a light source for light collection in the sagittal direction at a position displaced by L₁ₛ in a z₁-axis direction from an intersection point M₀ on the z₁ axis on the reflecting surface between the z₁ axis and the z₂ axis, and a light source for light collection in a meridional direction at a position displaced by L₁ₘ in the z₁-axis direction from the intersection point M₀ on the z₁ axis; causing outgoing beams to be collected at a position displaced by L₂ₛ in a z₂-axis direction from the intersection point M₀ on the z₂ axis for light collection in a sagittal direction and to be collected at a position displaced by L₂ₘ in the z₂-axis direction from the intersection point M₀ on the z₂ axis for light collection in a meridional direction; causing all incoming light rays passing through the mirror to pass through both a sagittal light source ray and a meridional light source ray, the sagittal light source ray passing through a position of the light source in the light collection in the sagittal direction and extending in a direction orthogonal to both the x₁ axis and the z₁ axis, the meridional light source ray passing through a position of the light source in light collection in the meridional direction and extending in a direction orthogonal to both the y₁ axis and the z₁ axis; causing all outgoing light rays emitted from the mirror to pass through both a sagittal collected light ray and a meridional collected light ray, the sagittal collected light ray passing through a collecting position in the light collection in the sagittal direction and extending in a direction orthogonal to both the x₂ axis and the z₂ axis, the meridional collected light ray passing through a collecting position in the light collection in the meridional direction and extending in a direction orthogonal to both the y₂ axis and the z₂ axis; representing any point on the reflecting surface of the mirror by M, expressing coordinates of an intersection point between the sagittal light source ray and an incoming light ray to the M point and an intersection point between the meridional light source ray and the incoming light ray to the M point by using the L₁ₛ and the L₁ₘ, and expressing coordinates of an intersection point between an outgoing light ray from the M point and the sagittal collected light ray and an intersection point between the outgoing light ray from the M point and the meridional collected light ray by using the L₂ₛ and the L₂ₘ; and designing the mirror by using design formulas of the reflecting surface derived based on the coordinates and a condition that an optical path length from a light source position to a light collection position is constant with respect to any point on the reflecting surface for both the light collection in the sagittal direction and the light collection in the meridional direction.

(2) The method for designing a mirror according to (1), in which the sagittal light source ray and the meridional light source ray are defined as a straight line Sₛ extending in a y₁-axis direction and a straight line Sₘ extending in an x₁-axis direction, respectively. The sagittal collected light ray and the meridional collected light ray are defined as a straight line Fₛ extending in a y₂-axis direction and a straight line Fₘ extending in an x₂-axis direction, respectively. An incoming length from the light source position to the M point with respect to the light collection in the sagittal direction is obtained as a distance to the M point from an intersection point on a side close to the meridional light source ray Sm of two intersection points between the incoming light ray and an equiphase plane A₁ₛ, the equiphase plane A₁ₛ being a rotated arcuate plane obtained by rotating, around the sagittal light source ray Sₛ, an arc that is formed around an intersection point Pₘ₀ between the meridional light source ray Sₘ and the z₁ axis and extends in a direction orthogonal to the x₁ axis through an intersection point Pₛ₀ between the sagittal light source ray Sₛ and the z₁ axis. An outgoing length from the M point to the light collection position with respect to the light collection in the sagittal direction is obtained as a distance to the M point from an intersection point on a side close to the meridional collected light ray Fₘ of two intersection points between the outgoing light ray and an equiphase plane A₂ₛ, the equiphase plane A₂ₛ being a rotated arcuate plane obtained by rotating, around the sagittal collected light ray Fₛ, an arc that is formed around an intersection point Qₘ₀ between the meridional collected light ray Fₘ and the z₂ axis and extends in a direction orthogonal to the x₂ axis through an intersection point Qₛ₀ between the sagittal collected light ray Fₛ and the z₂ axis. An incoming length from the light source position to the M point with respect to the light collection in the meridional direction is obtained as a distance to the M point from an intersection point on a side close to the sagittal light source ray Sₛ of two intersection points between the incoming light ray and an equiphase plane A₁ₘ, the equiphase plane A₁ₘ being a rotated arcuate plane obtained by rotating, around the meridional light source ray Sₘ, an arc that is formed around the intersection point Pₛ₀ between the sagittal light source ray Sₛ and the z₁ axis and extends in a direction orthogonal to the y₁ axis through the intersection point Pₘ₀ between the meridional light source ray Sₘ and the z₁ axis. An outgoing length from the M point to the light collection position with respect to the light collection in the meridional direction is obtained as a distance to the M point from an intersection point on a side close to the sagittal collected light ray Fₛ of two intersection points between the outgoing light ray and an equiphase plane A₂ₘ, the equiphase plane A₂ₘ being a rotated arcuate plane obtained by rotating, around the meridional collected light ray Fₘ, an arc that is formed around the intersection point Qₛ₀ between the sagittal collected light ray Fₛ and the z₂ axis and extends in a direction orthogonal to the y₂ axis through the intersection point Qₘ₀ between the meridional collected light ray Fₘ and the z₂ axis. The optical path length is calculated for the light collection in the sagittal direction and the light collection in the meridional direction.

(3) The method for designing a mirror according to (2), in which the distance to the M point from the intersection point on the side close to the meridional light source ray Sₘ of the two intersection points between the incoming light ray and the equiphase plane A₁ₛ is obtained by obtaining a distance to the M point from an intersection point Pₛ between the incoming light ray and the sagittal light source ray Sₛ and adding or subtracting, to or from the distance, a distance from the intersection point Pₛ to the arc defining the equiphase plane A₁ₛ. The distance to the M point from the intersection point on the de close to the meridional collected light ray Fₘ of the two intersection points between the outgoing light ray and the equiphase plane A₂ₛ is obtained by obtaining a distance to the M point from an intersection point Qs between the outgoing light ray and the sagittal collected light ray Fₛ and adding or subtracting, to or from the distance, a distance from the intersection point Qₛ to the arc defining the equiphase plane A₂ₛ. The distance to the M point from the intersection point on the side close to the sagittal light source ray Sₛ of the two intersection points between the incoming light ray and the equiphase plane A₁ₘ is obtained by obtaining a distance to the M point from an intersection point Pₘ between the incoming light ray and the meridional light source ray Sₘ and adding or subtracting, to or from the distance, a distance from the intersection point Pₘ to the arc defining the equiphase plane A₁ₘ. The distance to the M point from the intersection point on the side close to the sagittal collected light ray Fₛ of the two intersection points between the outgoing light ray and the equiphase plane A₂ₘ is obtained by obtaining a distance to the M point from an intersection point Qₘ between the outgoing light ray and the meridional collected light ray Fₘ and adding or subtracting, to or from the distance, a distance from the intersection point Qₘ to the arc defining the equiphase plane A₂ₘ.

(4) The method for designing a mirror according to any one of (1) to (3), in which a plane that includes an intersection point M₀ on the reflecting surface between the z₁ axis and the z₂ axis and is in contact with the reflecting surface is defined as a uv plane. A direction of a normal line passing through the M₀ in the uv plane is defined as a w axis. A v axis is a direction orthogonal to both the z₁ axis and the z₂ axis, and a u axis is a direction orthogonal to both the v axis and the w axis. An orthogonal coordinate system is defined based on a mirror, in which the intersection point M₀ is set as an origin, and an oblique incoming angle formed by a uv plane and an optical axis z₁ is represented by θ₀. The coordinates are transformed into an X₁y₁z₁ coordinate system based on an optical axis of the incoming beam and into an x₂y₂z₂ coordinate system based on an optical axis of the outgoing beam, respectively. A design formula is expressed by a uvw coordinate system.

(5) The method for designing a mirror according to (4), in which the design formula is obtained from a following formula (1) obtained by weighting both a first formula fₛ(u, v, w)=0 derived from a condition that an optical path length from a light source point to a light collection point is constant for the light collection in the sagittal direction, and a second formula fₘ(u, v, w)=0) derived from a condition that an optical path length from the light source point to the light collection point is constant for the light collection in the meridional direction.

[Math. 1]

f(u,v,w)=αfₛ(u,v,w)+βfₘ(u,v,w)=0

0≤α≤1, β=1−α (1)

(6) An astigmatism control mirror having a reflecting surface satisfying the design formula according to any one of (1) to (5), in which values of the L₁ₛ and the L₁ₘ are different from each other, and values of the L₂ₛ and the L₂ₘ are equal to each other. Outgoing beams which are collected at one point are obtained from an incoming beam having astigmatism.

(7) An astigmatism control mirror having a reflecting surface satisfying the design formula according to any one of (1) to (5), values of the L₁ₛ and the L₁ₘ are equal to each other, and values of the L₂ₛ and the L₂ₘ are different from each other. An outgoing beam having astigmatism is obtained from an incoming beam diverging from one point.

(8) An astigmatism control mirror having a reflecting surface satisfying the design formula according to any one of (1) to (5), in which values of the L₁ₘ and the L₂ₘ are positive or negative infinity, and each of the L₁ₛ and the L₂ₛ has a predetermined value (where L₁ₛ+L₂ₛ≠0). The astigmatism control mirror has light collection performance only in the sagittal direction.

### Advantageous Effects of Invention

According to a method for designing a mirror of the present invention, a light source position and a light collection position can be independently set in the vertical direction and the horizontal direction, and thereby a single mirror enabling free conversion of astigmatism can be manufactured. In addition, it is possible to cope with a beam in an X-ray region by further reducing a light collection size. Moreover, it is possible to manufacture the mirror that can be suitably used as an optical system which has a wide application range with a simple design formula and handles a beam having different characteristics between the vertical direction and the horizontal direction.

### BRIEF DESCRIPTION OF DRAWINGS

FIG. 1 is a conceptual diagram of a mirror designed by a designing method according to the present invention.

FIG. 2 is a conceptual diagram illustrating a coordinate system based on an incoming beam.

FIG. 3 is a conceptual diagram illustrating a coordinate system based on an outgoing beam.

FIG. 4 is a conceptual diagram illustrating an equiphase plane A₁ₛ in the vicinity of an intersection point Pₛ on a sagittal light source ray Sₛ.

FIG. 5 is a conceptual diagram illustrating an equiphase plane A₁ₘ in the vicinity of an intersection point Pₘ on a meridional light source ray Sₘ.

FIG. 6 is a schematic diagram illustrating an optical system arrangement of a mirror of Example 1.

FIGS. 7(a) to 7(c) illustrate calculated shapes of a mirror reflecting surface of Example 1, FIG. 7(a) illustrates a distribution of a height w(u, v) with respect to a mirror origin when a horizontal axis is set to a u coordinate and a vertical axis is set to a v coordinate, FIG. 7(b) illustrates a transverse cross-sectional profile taken along a one-dot chain line in FIG. 7(a), and FIG. 7(c) illustrates a longitudinal cross-sectional profile taken along a broken line in FIG. 7(a).

FIGS. 8(a) and 8(b) illustrate a simulation result of collection performance of Example 1, FIG. 8(a) illustrates a result of calculating variations of light rays on a light collecting surface on the basis of geometric optics, and FIG. 8(b) illustrates an intensity distribution on the light collecting surface calculated on the basis of wave optics by assuming a soft X-ray of 300 eV.

FIG. 9 is a schematic diagram illustrating an optical system arrangement of a mirror of Example 2.

FIGS. 10(a) to 10(c) illustrate calculated shapes of a mirror reflecting surface of Example 2, FIG. 10(a) illustrates a distribution of a height w(u, v) with respect to a mirror origin when a horizontal axis is set to a u coordinate and a vertical axis is set to a v coordinate, FIG. 10(b) illustrates a transverse cross-sectional profile taken along a one-dot chain line in FIG. 10(a), and FIG. 10(c) illustrates a longitudinal cross-sectional profile taken along a broken line in FIG. 10(a).

FIGS. 11(a) and 11(b) illustrate a simulation result of light collection performance of Example 2, FIG. 11(a) illustrates a result of calculating variations of light rays on a light collecting surface on the basis of geometric optics, and FIG. 11(b) illustrates an intensity distribution on the light collecting surface, which is calculated on the basis of wave optics by assuming a soft X-ray of 300 eV.

FIG. 12 is a schematic diagram illustrating an optical system arrangement of a mirror of Example 3.

FIGS. 13(a) to 13(c) illustrate calculated shapes of a mirror reflecting surface of Example 3, FIG. 13(a) illustrates a distribution of a height w(u, v) with respect to a mirror origin when a horizontal axis is set to a u coordinate and a vertical axis is set to a v coordinate, FIG. 13(b) illustrates a transverse cross-sectional profile taken along a one-dot chain line in FIG. 13(a), and FIG. 13(c) illustrates a longitudinal cross-sectional profile taken along a broken line in FIG. 13(a).

FIGS. 14(a) to 14(d) illustrate a simulation result of light collection performance of Example 3. FIG. 14(a) illustrates a result of calculating variations of light rays on a light collecting surface on the basis of geometric optics. regarding vertical (meridional) light collecting surface, FIG. 14(b) illustrates an intensity distribution on the light collecting surface, which is calculated by assuming a soft X-ray of 300 eV, regarding the same light collecting surface, FIG. 14(c) illustrates a result of calculating variations of light rays on a light collecting surface on the basis of geometric optics, regarding a horizontal (sagittal) light collecting surface, and FIG. 14(d) illustrates an intensity distribution on the light collecting surface, which is calculated by assuming a soft X-ray of 300 eV, regarding the same light collecting surface.

FIG. 15 is a schematic diagram illustrating an optical system arrangement of a mirror of Example 4.

FIGS. 16(a) to 16(c) illustrate calculated shapes of a mirror reflecting surface of Example 4, FIG. 16(a) illustrates a distribution of a height w(u, v) with respect to a mirror origin when a horizontal axis is set to a u coordinate and a vertical axis is set to a v coordinate, FIG. 16(b) illustrates a transverse cross-sectional profile taken along a one-dot chain line in FIG. 16(a), and FIG. 16(c) illustrates a longitudinal cross-sectional profile taken along a broken line in FIG. 16(a).

FIG. 17 is a diagram illustrating a difference from a truncated cone having a mirror shape of Example 4.

FIGS. 18(a) and 18(b) illustrate a simulation result of light collection performance in a sagittal direction of Example 4, FIG. 18(a) illustrates a result of calculating variations of light rays on a light collecting surface on the basis of geometric optics, and FIG. 18(b) illustrates an intensity distribution on the light collecting surface, which is calculated on the basis of wave optics by assuming a soft X-ray of 300 eV.

FIGS. 19(a) to 19(c) are diagrams illustrating height distributions of reflecting surfaces of mirrors of Example 1 and Comparative Examples 1 and 2.

FIG. 20 is a diagram illustrating a result obtained by subtracting the height distribution of the mirror of Example 1 from the height distribution of the mirror of Comparative Example 2.

FIGS. 21(a) to 21(f) illustrate simulation results of light collection performance, FIG. 21(a) illustrates variations of light rays of Comparative Example 1 (toroidal mirror), FIG. 21(b) illustrates a two-dimensional intensity distribution at 300 eV calculated based on wave optics of Comparative Example 1, FIG. 21(c) illustrates variations of light rays of Comparative Example 2 (astigmatic off-axis mirror), FIG. 21(d) illustrates a two-dimensional intensity distribution at 300 eV calculated based on wave optics of Comparative Example 2, FIG. 21(e) illustrates variations of light rays of Example 1 (astigmatism control mirror according to the present invention), and FIG. 21(f) illustrates a two-dimensional intensity distribution at 300 eV calculated based on wave optics of Example 1.

### DESCRIPTION OF EMBODIMENTS

A method for designing a mirror of the present invention is a method for designing a mirror manufactured by forming a reflecting surface on a plate surface. Hereinafter, the method for designing a mirror according to the present invention will be described with reference to representative embodiments.

An object of the present invention is to freely convert astigmatism, and a mirror is designed with higher accuracy based on Fermat's principle that “light passes through a path with the shortest optical distance”. When limited to a collecting (or diffusing) mirror, Fermat's principle can be converted into an expression that “a sum of a distance from a light source point and a distance to a light collection point is constant for any point on a mirror surface (reflecting surface)”. When an incoming beam or an outgoing beam has astigmatism, a law of a constant optical path length cannot be applied directly. This is because a beam having astigmatism does not have a single light source point or light collection point as the name indicates. In the present invention, a design method is realized by conceiving that a “light source ray” and a “collected light ray” are newly defined and properties of a beam having astigmatism can be geometrically and optically expressed.

FIG. 1 is a conceptual diagram illustrating a “light source ray” and a “collected light ray”. Regarding light collection in a sagittal direction, it is assumed that the incoming beam has a light source at a position displaced by L₁ₛ from an intersection point M₀ that is an intersection point on a reflecting surface between a z₁ axis and a z₂ axis on an optical axis z₁ of incoming light, and an outgoing beam is collected at a position displaced by L₂ₛ along an optical axis from the intersection point M₀ on an optical axis z₂ of outgoing light. In addition, regarding light collection in a meridional direction, it is assumed that the incoming beam has a light source at a position displaced by L₁ₘ from an intersection point Me that is an intersection point on the optical axis z₁ of the incoming light, and an outgoing beam is collected at a position displaced by L₂ₘ from the intersection point M₀ on the optical axis z₂ of the outgoing light.

All of incoming light rays passing through the mirror are considered to pass through both a sagittal light source ray (Sₛ) that passes through the position of the light source in the light collection in the sagittal direction and extends in a direction (y₁-axis direction to be described below) orthogonal to both the optical axis z₁ of the incoming light and the sagittal direction, and a meridional light source ray (Sₘ) that passes through the position of the light source in the light collection in the meridional direction and extends in the sagittal direction (x₁-axis direction to be described below). In this manner, the sagittal light source ray (Sₛ) and the meridional light source ray (Sₘ) are defined.

All of outgoing light rays emitted from the mirror are considered to pass through both a sagittal collected light ray (Fₛ) that passes through a collecting position in the light collection in the sagittal direction and extends in a direction (y₂-axis direction to be described below) orthogonal to both the optical axis z₂ of the outgoing light and the sagittal direction, and a meridional collected light ray (Fₘ) that passes through a collecting position in the light collection in the meridional direction and extends in the sagittal direction (x₂-axis direction to be described below). In this manner, the sagittal collected light ray (Fₛ) and the meridional collected light ray (Fₘ) are defined.

In the present example, the sagittal light source ray (Sₛ), the meridional light source ray (Sₘ), the sagittal collected light ray (Fₛ), and the meridional collected light ray (Fₘ) are all straight lines, but may be curved lines. In addition, FIG. 1 illustrates a case where L₁ₛ>L₁ₘ>0 and L₂ₛ>L₂ₘ>0, but these constants may take negative values. When L₁ₛ or L₁ₘ takes a negative value, the incoming beams are reflected by the reflecting surface of the mirror on the way of collecting toward downstream. When L₂ₛ or L₂ₘ takes a negative value, the outgoing beams have a wavefront that diverges from a position located upstream from the mirror.

By defining the “light source ray” and the “collected light ray” as described above, an incoming light ray and an outgoing light ray passing through any point on the reflecting surface of the mirror can be defined. Specifically, any point on the reflecting surface of the mirror is represented by M, coordinates of an intersection point (Pₛ) between the sagittal light source ray (Sₛ) and an incoming light ray to the M point and an intersection point (Pₘ) between the meridional light source ray (Sₘ) and the incoming light ray to the M point can be expressed by a formula using the displacements L₁ₛ and L₁ₘ. Similarly, coordinates of an intersection point (Qₛ) between an outgoing light ray from the M point and the sagittal collected light ray (Fₛ) and an intersection point (Qₘ) between the outgoing light ray from the M point and the meridional collected light ray (Fₘ) can be expressed by a formula using the displacements L₂ₛ and L₂ₘ.

The design formula of the reflecting surface can be derived based on the respective coordinates of Pₛ, Pₘ, Qₛ, and Qₘ, and a condition that an optical path length (a sum of an incoming length and an outgoing length) from the light source position to the light collection position is constant with respect to any point on the reflecting surface in the light collection in the sagittal direction and the light collection in the meridional direction.

Any point M on the reflecting surface of the mirror can be represented by M(u, v, w) by defining a uvw orthogonal coordinate system on the basis of the mirror. Specifically, a plane that includes the intersection point M₀ on the reflecting surface of the incoming light and the outgoing light and is in contact with the reflecting surface is defined as a uv plane, a direction of a normal line passing through M₀ of the uv plane is defined as a w axis, a v axis is defined as a direction orthogonal to both the incoming optical axis and an outgoing optical axis, a u axis is defined as a direction orthogonal to both the v axis and the w axis, the intersection point M₀ is defined as an origin, and an oblique incoming angle formed by the uv plane and the optical axis z₁ is represented by θ₀.

However, in FIG. 1, it should be noted that the sagittal light source ray (Sₛ) and the meridional light source ray (Sₘ) are not orthogonal to the u axis but are orthogonal to the optical axis z₁ of the incoming beam. Similarly, the sagittal collected light ray (Fₛ) and the meridional collected light ray (Fₘ) are orthogonal to the optical axis z₂ of the outgoing beam. Although it is also possible to calculate an optical path length directly from the light source ray and the collected light ray which are obliquely set with respect to the uvw coordinate system, the calculation is not simple. Therefore, in the embodiment, the optical path length is calculated by converting the coordinate system into a coordinate system based on each of an incoming beam optical axis and an outgoing beam optical axis, and an obtained resultant is substituted in the design formula of the astigmatism control mirror.

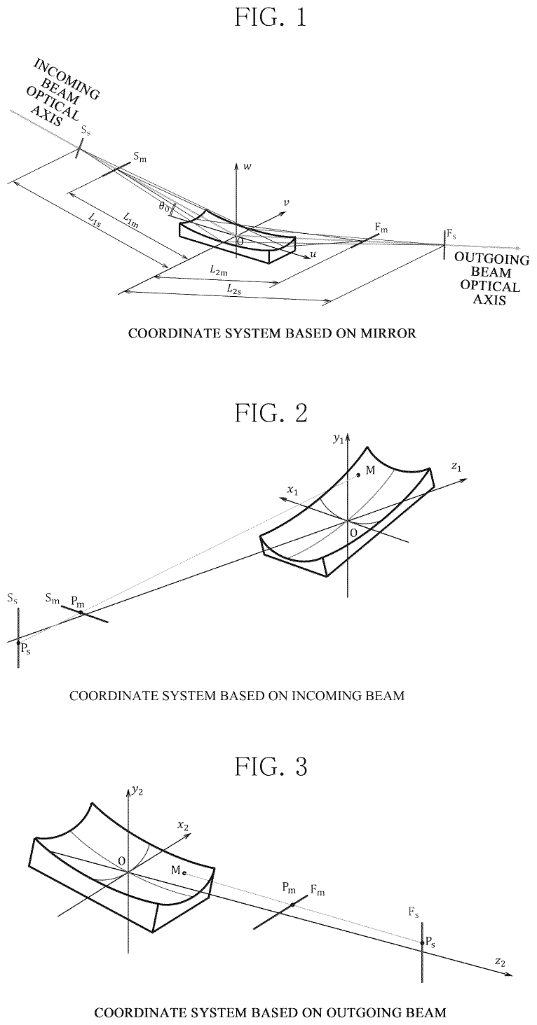

The conversion into the coordinate system based on the incoming beam optical axis is as follows. FIG. 2 illustrates a schematic diagram of a converted coordinate system. An optical axis of the incoming beam is defined as the z₁ axis, and a cross section orthogonal to the z₁ axis is defined as an x₁y₁ plane. Each coordinate of each point M(x₁, y₁, z₁) on the mirror is given by Formula (2).

[Math. 2]

(x₁,y₁,z₁)=(v,u sin θ₀+w cos θ₀u cos θ₀−w sin θ₀) (2)

A coordinate of the intersection point Pₛ between the incoming light ray passing through the point M and the sagittal light source ray Sₛ and a coordinate of the intersection point Pₘ between the same incoming light ray and the meridional light source ray Sₘ can be expressed respectively by the following formulas (3) and (4) using displacements L₁ₛ and L₁ₘ, on the X₁y₁z₁ coordinate system.

$$\begin{matrix}[ Math . 3 ] & \\ {P}_{s} = ( 0 , ( {L}_{1 m} - {L}_{1 s} ) \frac{{y}_{1}}{{z}_{1} + {L}_{1 m}} , - {L}_{1 s} ) & ( 3 )\end{matrix}$$

$${P}_{m} = ( ( {L}_{1 s} - {L}_{1 m} ) \frac{{x}_{1}}{{z}_{1} + {L}_{1 s}} , 0 , - {L}_{1 m} ) \qquad ( 4 )$$

Similarly, the conversion into the coordinate system based on the outgoing beam optical axis is as follows. FIG. 3 illustrates a schematic diagram of a converted coordinate system. An optical axis of an outgoing beam is defined as the z₂ axis, and a cross section orthogonal to the z₂ axis is defined as an x₂y₂ plane. Each coordinate of each point M(x₂, y₂, z₂) on the mirror is given by Formula (5).

[Math. 4]

(x₂,y₂,z₂)=(v,−u sin θ₀+w cos θ₀+w sin θ₀) (5)

A coordinate of the intersection point Qₛ between the outgoing light ray passing through the point M and the sagittal collected light ray Fₛ and a coordinate of the intersection point Qₘ between the outgoing light ray and the meridional collected light ray Fₘ can be expressed respectively by the following formulas (6) and (7) using the displacements L₂ₛ and L₂ₘ, on the x₂y₂z₂ coordinate system.

$$\begin{matrix}[ Math . 5 ] & \\ {Q}_{s} = ( 0 , ( {L}_{2 m} - {L}_{2 s} ) \frac{{y}_{2}}{{L}_{2 m} - {z}_{2}} , {L}_{2 s} ) & ( 6 )\end{matrix}$$

$${Q}_{m} ( ( {L}_{2 s} - {L}_{2 m} ) \frac{{x}_{2}}{{L}_{2 s} - {z}_{2}} , 0 , {L}_{2 m} ) \qquad ( 7 )$$

As described above, design formulas of the reflecting surface are derived based on the respective coordinates of Pₛ, Pₘ, Qₛ, and Qₘ, and a condition that an optical path length (a sum of an incoming length and an outgoing length) from the light source position to the light collection position is constant with respect to any point on the reflecting surface in the light collection in the sagittal direction and the light collection in the meridional direction.

In the embodiment, the distance between each of the intersection points Pₛ, Pₘ, Qₛ, and Qₘ on the light source ray and the collected light ray described above and any point M on the reflecting surface is not set as an incoming length or an outgoing length as it is, but is calculated by performing the following compensation for an optical path length so as to obtain a more accurate design formula while using the coordinates of the intersection points on the light source ray and the collected light ray defined as a straight line.

### (Optical Path Length Compensation)

Fermat's principle in a case where a normal light source point and a light collection point can be defined is considered. An equiphase plane in the vicinity of the light source point is a spherical plane around the light source point, and an equiphase plane in the vicinity of the light collection point is a spherical plane around the light collection point. Keeping in mind that light rays are always orthogonal to an equiphase plane, the law of constant optical path length is paraphrased as the fact that an optical distance of a light ray connecting any point on a specific equiphase plane in the vicinity of a light source point and a point on a specific equiphase plane in the vicinity of a light collection point corresponding to the aforementioned any point is constant. Even in a case where an incoming beam as in the present invention has astigmatism. a more accurate design formula can be derived by performing compensation in consideration of the equiphase plane.

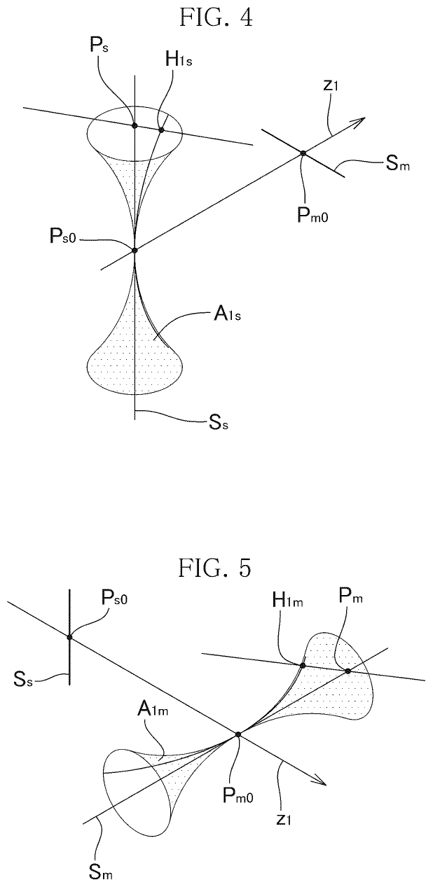

First, regarding the incoming side, an equiphase plane in the vicinity corresponding to the above-described intersection point Pₛ on the sagittal light source ray Sₛ is considered. On the sagittal light source ray Sₛ, a wavefront converging toward the meridional light source ray Sₘ should be observed. Although it is not strictly possible to define a phase on the sagittal light source ray Sₛ on the basis of such an assumption described above, here, an intersection point between Sₘ and the z₁ axis is represented by Pₘ₀, and it is assumed that a phase distribution corresponding to a distance from Pₘ₀ is present on Sₛ, i.e., a beam before incoming to the mirror (reflecting surface) has a wavefront concentrated on the meridional light source ray Sₘ in the y₁-axis direction. Based on this idea, as illustrated in FIG. 4, a rotated arcuate plane formed by rotating, around the sagittal light source ray Sₛ, an arc B₁ₛ around the intersection point Pₘ₀ between the meridional light source ray Sₘ and the z₁ axis and extends in a direction orthogonal to the x₁ axis through the intersection point Pₛ₀ between the sagittal light source ray Sₛ and the z₁ axis is defined as an equiphase plane A₁ₛ. An incoming length from the light source position to the M point in the sagittal direction is more accurately obtained as a distance to the M point from an intersection point on a side close to the meridional light source ray Sₘ of two intersection points between the incoming light ray and the equiphase plane A₁ₛ.

Here, a distance from the intersection point between the incoming light ray and the equiphase plane A₁ₛ to the M point on the reflecting surface of the mirror is obtained by first obtaining a distance from the intersection point Pₛ between the incoming light ray and the sagittal light source ray Sₛ to the M point and adding or subtracting (subtracting in the example of the drawing), to or from a distance, the distance being from the intersection point Pₛ to the arc B₁ₛ defining the equiphase plane A₁ₛ, i.e., a distance between Pₛ and H₁ₛ where H₁ₛ represents a foot of a perpendicular line drawn from Pₛ to the arc B₁ₛ. That is, an incoming length f₁ₛ is expressed by Formula (8). The reason why this formula is an approximate formula is that there is no guarantee that the point H₁ₛ is present on a straight line from Pₛ to M. However, it is needless to say that the incoming length may be obtained by calculation other than the approximate formula. In the example, the incoming length is approximately obtained by adding/subtracting the distance between Pₛ and H₁ₛ where H₁ₛ represents the foot of the perpendicular line drawn from Pₛ to the arc B₁ₛ as described above, but the incoming length may be more accurately calculated using a distance from Pₛ to the intersection point on the side close to the meridional light source ray Sₘ among the two intersection points between the incoming light ray and the equiphase plane A₁ₛ instead of the perpendicular line drawn to the arc B₁ₛ.

$$\begin{matrix}[ Math . 6 ] & \\ {f}_{1 s} ( u , v , w ) = \vert \vec{{P}_{s} M} \vert - \vert \vec{{P}_{s} {H}_{1 s}} \vert = \sqrt{{x}_{1}^{2} + {( {y}_{1} - ( {L}_{1 m} - {L}_{1 s} ) \frac{{y}_{1}}{{z}_{1} + {L}_{1 m}} )}^{2} + {( {z}_{1} + {L}_{1 s} )}^{2}} - \{ \sqrt{{( {L}_{1 s} - {L}_{1 m} )}^{2} + {( {L}_{1 m} - {L}_{1 s} )}^{2} {( \frac{{y}_{1}}{{z}_{1} + \text{?}} )}^{2}} - ( {L}_{1 s} - {L}_{1 m} ) \} = ( {z}_{1} + {L}_{1 s} ) \sqrt{1 + {( \frac{{x}_{1}}{{z}_{1} + {L}_{1 s}} )}^{2} + {( \frac{{y}_{1}}{{z}_{1} + {L}_{1 m}} )}^{2}} - ( {L}_{1 s} - {L}_{1 m} ) \{ \sqrt{1 + {( \frac{{y}_{1}}{{z}_{1} + {L}_{1 m}} )}^{2}} - 1 \} & ( 8 )\end{matrix}$$

$$\text{?} \text{indicates text missing or illegible when filed}$$

By introducing t′₁ₓ (Formula (10)) and t′_{1y} (Formula (11)) to the formula, the formula can be transformed into the following formula (9).

$$\begin{matrix}[ Math . 7 ] & \\ {f}_{1 s} ( u , v , w ) = {z}_{1} \sqrt{1 + {t}_{1 x}^{′2} + {t}_{1 y}^{′2}} + {L}_{1 m} ( \sqrt{1 + {t}_{1 y}^{′2}} - 1 ) + {L}_{1 s} ( \sqrt{1 + {t}_{1 x}^{′2} + {t}_{1 y}^{′2}} - \sqrt{1 + {t}_{1 y}^{′2}} + 1 ) & ( 9 )\end{matrix}$$

$${t}_{1 x}^{′} = \frac{{x}_{1}}{{z}_{1} + {L}_{1 s}} \qquad ( 10 )$$

$${t}_{1 y}^{′} = \frac{{y}_{1}}{{z}_{1} + {L}_{1 m}} \qquad ( 11 )$$

Subsequently, similarly, regarding the incoming side, an equiphase plane in the vicinity corresponding to the above-described intersection point Pₘ on the meridional light source ray Sₘ is considered. On the meridional light source ray Sₘ, a wavefront diverging from the sagittal light source ray Sₛ should be observed. Although it is not strictly possible to define a phase on the Sₘ on the basis of such an assumption described above, here, an intersection point between Sₛ and the z₁ axis is represented by Pₛ₀, and it is assumed that a phase distribution corresponding to a distance from Pₛ₀ is present on Sₘ, i.e., a beam before incoming to the mirror (reflecting surface) has a wavefront diverging from the sagittal light source ray Sₛ in the x₁-axis direction. Based on this idea, as illustrated in FIG. 5, a rotated arcuate plane formed by rotating, around the meridional light source ray Sₘ, an arc B₁ₘ around the intersection point Pₛ₀ between the sagittal light source ray Sₛ and the z₁ axis and extends in a direction orthogonal to the y₁ axis through the intersection point Pₘ₀ between the meridional light source ray Sₘ and the z₁ axis is defined as an equiphase plane A₁ₘ. An incoming length from the light source position to the M point in the y₁-axis direction is obtained as a distance to the M point on the reflecting surface of the mirror from an intersection point on a side close to the sagittal light source ray Sₛ among two intersection points between the incoming light ray and the equiphase plane A₁ₘ.

A distance from the intersection point between the incoming light ray and the equiphase plane A₁ₘ to the M point is obtained by first obtaining a distance from the intersection point Pₘ between the incoming light ray and the meridional light source ray Sₘ to the M point and adding or subtracting (adding in the example), to or from a distance, the distance being from the intersection point Pₘ to the arc B₁ₘ defining the equiphase plane A₁ₘ, i.e., a distance between Pₘ and H₁ₘ where H₁ₘ represents a foot of a perpendicular line drawn from Pₘ to the arc B₁ₘ. That is, an incoming length f₁ₘ is expressed by Formula (12).

$$\begin{matrix}[ Math . 8 ] & \\ {f}_{1 m} ( u , v , w ) = \vert \vec{{P}_{m} M} \vert + \vert \vec{{H}_{1 m} {P}_{m}} \vert = \sqrt{{( {x}_{1} + ( {L}_{1 s} - {L}_{1 m} ) \frac{{x}_{1}}{{z}_{1} + {L}_{1 s}} )}^{2} + {y}_{1}^{2} + {( {z}_{1} + {L}_{1 m} )}^{2}} + \{ \sqrt{{( {L}_{1 s} - {L}_{1 m} )}^{2} + {( {L}_{1 s} - {L}_{1 m} )}^{2} {( \frac{{x}_{1}}{{z}_{1} + {L}_{1 s}} )}^{2}} - ( {L}_{1 s} - {L}_{1 m} ) \} = ( {z}_{1} + {L}_{1 m} ) \sqrt{1 + {( \frac{{x}_{1}}{{z}_{1} + {L}_{1 s}} )}^{2} + {( \frac{{y}_{1}}{{z}_{1} + {L}_{1 m}} )}^{2}} + ( {L}_{1 s} - {L}_{1 m} ) \{ \sqrt{1 + {( \frac{{x}_{1}}{{z}_{1} + {L}_{1 s}} )}^{2}} - 1 \} & ( 12 )\end{matrix}$$

By introducing t′₁ₓ and t′_{1y} to the formula, the formula can be transformed into the following formula (13).

$$\begin{matrix}[ Math . 9 ] & \\ {f}_{1 m} ( u , v , w ) = {z}_{1} \sqrt{1 + {t}_{1 x}^{′2} + {t}_{1 y}^{′2}} + {L}_{1 m} ( \sqrt{1 + {t}_{1 x}^{′2} + {t}_{1 y}^{′2}} - \sqrt{1 + {t}_{1 x}^{′2}} + 1 ) + {L}_{1 s} ( \sqrt{1 + {t}_{1 x}^{′2}} - 1 ) & ( 13 )\end{matrix}$$

Regarding an outgoing side, similarly to the incoming side, an equiphase plane in the vicinity corresponding to the intersection point Qₛ on the sagittal collected light ray Fₛ and an equiphase plane in the vicinity corresponding to the intersection point Qₘ on the meridional collected light ray Fₘ are considered. On the sagittal collected light ray Fₛ, a wavefront diverging from the meridional collected light ray Fₘ should be observed. Although it is not strictly possible to define a phase on Fₛ on the basis of such an assumption, here, an intersection point between Fₘ and the outgoing optical axis z₂ is represented by Qₘ₀, and it is assumed that a phase distribution corresponding to a distance from Qₘ₀ is present on Fₛ. In addition, on the meridional collected light ray Fₘ, a wavefront converging toward the sagittal collected light ray Fₛ should be observed. Although it is not possible to strictly define a phase on Fₘ based on such an assumption, here, an intersection point between Fₛ and the outgoing optical axis z₂ is represented by Qₛ₀, and it is assumed that a phase distribution corresponding to the distance from Qₛ₀ is present on Fₘ.

Based on these ideas, a more accurate outgoing length is obtained similarly to the incoming side. Specifically, although illustration is omitted, in the same manner as described above, compensation is performed by addition or subtraction using a distance from the intersection point Qₛ to an arc B₂ₛ defining an equiphase plane, i.e., a distance between H₂ₛ and Qₛ, where H₂ₛ represents a foot of a perpendicular line drawn from Qₛ to the arc B₂ₛ, and a distance from the intersection point Qₘ to an arc B₂ₘ defining an equiphase plane, i.e., a distance between Qₘ and H₂ₘ, where Ham represents a foot of a perpendicular line drawn from Qₘ to the arc B2m, and both outgoing lengths of an outgoing length f₂ₛ in the light collection in the sagittal direction and an outgoing length f₂ₘ in the light collection in the meridional direction can be more accurately obtained as in Formulas (14) and (15).

$$\begin{matrix}[ Math . 10 ] & \\ {f}_{2 s} ( u , v , w ) = \vert \vec{{MQ}_{s}} \vert - \vert \vec{{H}_{2 m} {Q}_{s}} \vert = \sqrt{{x}_{2}^{2} + {( ( {L}_{2 m} - {L}_{2 s} ) \frac{{y}_{2}}{{L}_{2 m} + {z}_{2}} - {y}_{2} )}^{2} + {( {L}_{2 s} + {z}_{2} )}^{2}} - \{ \sqrt{{( {L}_{2 s} - {L}_{2 m} )}^{2} + {( {L}_{2 m} - {L}_{2 s} )}^{2} {( \frac{{y}_{2}}{{L}_{2 m} + {z}_{2}} )}^{2}} - ( {L}_{2 s} - {L}_{2 m} ) \} = ( {L}_{2 s} + {z}_{2} ) \sqrt{1 + {( \frac{{x}_{2}}{{L}_{2 s} + {z}_{2}} )}^{2} + {( \frac{{y}_{2}}{{L}_{2 m} + {z}_{2}} )}^{2}} - ( {L}_{2 s} - {L}_{2 m} ) \{ \sqrt{1 + {( \frac{{y}_{2}}{{L}_{2 m} + {z}_{2}} )}^{2}} - 1 \} & ( 14 )\end{matrix}$$

$$\begin{matrix}[ Math . 11 ] & \\ {f}_{2 m} ( u , v , w ) = \vert \vec{{MQ}_{m}} \vert + \vert \vec{{Q}_{m} {H}_{2 m}} \vert = \sqrt{{( ( {L}_{2 s} - {L}_{2 m} ) \frac{{x}_{2}}{{L}_{2 s} + {z}_{2}} - {x}_{2} )}^{2} + {y}_{2}^{2} + {( {L}_{2 m} + {z}_{2} )}^{2}} + \{ \sqrt{{( {L}_{2 s} - {L}_{2 m} )}^{2} + {( {L}_{2 s} - {L}_{2 m} )}^{2} {( \frac{{x}_{2}}{{L}_{2 s} + {z}_{2}} )}^{2}} - ( {L}_{2 s} - {L}_{2 m} ) \} = ( {L}_{2 m} + {z}_{2} ) \sqrt{1 + {( \frac{{x}_{2}}{{L}_{2 s} + {z}_{2}} )}^{2} + {( \frac{{y}_{2}}{{L}_{2 m} + {z}_{2}} )}^{2}} + ( {L}_{2 s} - {L}_{2 m} ) \{ \sqrt{1 + {( \frac{{x}_{2}}{{L}_{2 s} + {z}_{2}} )}^{2}} - 1 \} & ( 15 )\end{matrix}$$

f₂ₛ can be transformed as in the following formulas (16) to (18) by introducing t′₂ₓ and t′_{2y}.

$$\begin{matrix}[ Math . 12 ] & \\ {f}_{2 s} ( u , v , w ) = - {z}_{2} \sqrt{1 + {t}_{2 x}^{′2} + {t}_{2 y}^{′2}} + {L}_{2 m} ( \sqrt{1 + {t}_{2 y}^{′2}} - 1 ) + {L}_{2 s} ( \sqrt{1 + {t}_{2 x}^{′2} + {t}_{2 y}^{′2}} - \sqrt{1 + {t}_{2 y}^{′2}} + 1 ) & ( 16 )\end{matrix}$$

$${t}_{2 x}^{′} = \frac{{x}_{2}}{{L}_{2 s} + {z}_{2}} \qquad ( 17 )$$

$${t}_{2 y}^{′} = \frac{{y}_{2}}{{L}_{2 m} + {z}_{2}} \qquad ( 18 )$$

f₂ₘ can be transformed as in the following formula (19) by introducing t′₂ₓ and t′_{2y}.

$$\begin{matrix}[ Math . 13 ] & \\ {f}_{2 m} ( u , v , w ) = - {z}_{2} \sqrt{1 + {t}_{2 x}^{′2} + {t}_{2 y}^{′2}} + {L}_{2 m} ( \sqrt{1 + {t}_{2 x}^{′2} + {t}_{2 y}^{′2}} - \sqrt{1 + {t}_{2 x}^{′2}} + 1 ) + {L}_{2 s} ( \sqrt{1 + {t}_{2 x}^{′2}} - 1 ) & ( 19 )\end{matrix}$$

### (Calculation of Optical Path Length)

By using the incoming length and the outgoing length obtained in the above-described manner, the optical path length for the light collection in each of the sagittal direction and the meridional direction is calculated. When a reference optical path length from the light source point to the light collection point in the light collection in the sagittal direction is defined as Lₛ=L₁ₛ+L₂ₛ, a conditional formula suitable for the light collection in the sagittal direction is derived as in the following formula (20).

$$\begin{matrix}[ Math . 14 ] & \\ {f}_{s} ( u , v , w ) = {f}_{1 s} ( u , v , w ) + {f}_{2 s} ( u , v , w ) - {L}_{s} = {z}_{1} \sqrt{1 + {t}_{1 x}^{′2} + {t}_{1 y}^{′2}} - {z}_{2} \sqrt{1 + {t}_{2 x}^{′2} + {t}_{2 y}^{′2}} + {L}_{1 m} ( \sqrt{1 + {t}_{1 y}^{′2}} - 1 ) + {L}_{1 s} ( \sqrt{1 + {t}_{1 x}^{′2} + {t}_{1 y}^{′2}} - \sqrt{1 + {t}_{2 y}^{′2}} ) + {L}_{2 m} ( \sqrt{1 + {t}_{2 y}^{′2}} - 1 ) + {L}_{2 s} ( \sqrt{1 + {t}_{2 x}^{′2} + {t}_{2 y}^{′2}} - \sqrt{1 + {t}_{2 y}^{′2}} ) ) = 0 & ( 20 )\end{matrix}$$

Similarly, when a reference optical path length from the light source point to the light collection point in the light collection in the meridional direction is defined as Lₘ=L₁ₘ+L₂ₘ, a conditional formula suitable for the light collection in the meridional direction is derived as in the following formula (21).

$$\begin{matrix}[ Math . 15 ] & \\ {f}_{m} ( u , v , w ) = {f}_{1 m} ( u , v , w ) + {f}_{2 m} ( u , v , w ) - {L}_{m} = {z}_{1} \sqrt{1 + {t}_{1 x}^{′2} + {t}_{1 y}^{′2}} - {z}_{2} \sqrt{1 + {t}_{2 x}^{′2} + {t}_{2 y}^{′2}} + {L}_{1 m} ( \sqrt{1 + {t}_{1 x}^{′2} + {t}_{1 y}^{′2}} - \sqrt{1 + {t}_{1 x}^{′2}} ) + {L}_{1 s} ( \sqrt{1 + {t}_{1 x}^{′2}} - 1 ) + {L}_{2 m} ( \sqrt{1 + {t}_{2 x}^{′3} + {t}_{2 y}^{′2}} - \sqrt{1 + {t}_{2 x}^{′2}} ) + {L}_{2 s} ( \sqrt{1 + {t}_{2 x}^{′2}} - 1 ) = 0 & ( 21 )\end{matrix}$$

Ideally, a shape of the reflecting surface of the mirror is obtained by a set of points (u, v, w) that simultaneously satisfy a light collection condition in the sagittal direction in Formula (20) and the light collection condition in the meridional direction in Formula (21). However, if a solution to the simultaneous equations is a design formula, the shape is formed under a special condition such as “L₁ₛ=L₁ₘ and L₂ₛ=L₂ₘ”. In order to obtain a design formula representing a more generalized shape of the reflecting surface, which can be established even under other conditions, the present inventors have weighted Formulas (20) and (21) and establishes a new Formula f(u, v, w)=0 provided in Formula (22) as the design formula.

### (Design Formula)

That is, the design formula is the formula f(u, v, w)=0 obtained by weighting Fₛ(u, v, w)=0 (formula (20)) that is a first formula (formula of a sagittal direction light collection condition) derived from a condition that the optical path length from the light source point to the light collection point in the light collection in the sagittal direction is constant, and Fₘ(u, v, w)=0) (Formula (21)) that is a second formula (formula of a meridional direction light collection condition) derived from a condition that the optical path length from the light source point to the light collection point in the light collection in the meridional direction is constant, by using α and β as the following formula (22). α is a weighting coefficient for the light collection in the meridional direction, and β is a weighting coefficient for the light collection in the sagittal direction.

$$\begin{matrix}[ Math . 16 ] & \\ f ( u , v , w ) = {z}_{1} \sqrt{1 + {t}_{1 x}^{′2} + {t}_{1 y}^{′2}} - {z}_{2} \sqrt{1 + {t}_{2 x}^{′2} + {t}_{2 y}^{′2}} + {L}_{1 m} ( α \sqrt{1 + {t}_{1 x}^{′2} + {t}_{1 y}^{′2}} - α \sqrt{1 + {t}_{1 x}^{′2}} + β \sqrt{1 + {t}_{1 y}^{′2}} - β ) + {L}_{1 s} ( β \sqrt{1 + {t}_{1 x}^{′2} + {t}_{1 x}^{′2}} + α \sqrt{1 + {t}_{1 x}^{′2}} - β \sqrt{1 + {t}_{1 y}^{′2}} - α ) + {L}_{2 m} ( α \sqrt{1 + {t}_{2 x}^{′2} + {t}_{2 y}^{′2}} - α \sqrt{1 + {t}_{2 x}^{′2}} + β \sqrt{1 + {t}_{2 y}^{′2}} - β ) + {L}_{2 s} ( β \sqrt{1 + {t}_{2 x}^{′2} + {t}_{2 y}^{′2}} + α \sqrt{1 + {t}_{2 x}^{′2}} - β \sqrt{1 + {t}_{2 y}^{′2}} - α ) = 0 & ( 22 )\end{matrix}$$

Formula (22) is a design formula of the mirror. When t′₁ₓ, t′_{1y}, t′₂ₓ, and t′_{2y} in the formula are rewritten on the basis of the uvw coordinate system, the following formulas (23) to (26) are obtained.

$$\begin{matrix}[ Math . 17 ] & \\ {t}_{1 x}^{′} = \frac{v}{u cos {θ}_{0} - w sin {θ}_{0} + {L}_{1 s}} & ( 23 )\end{matrix}$$

$${t}_{1 y}^{′} = \frac{u sin {θ}_{0} + w cos {θ}_{0}}{u cos {θ}_{0} - w sin {θ}_{0} + {L}_{1 m}} \qquad ( 24 )$$

$${t}_{2 x}^{′} = \frac{v}{{L}_{2 s} - u cos {θ}_{0} - w sin {θ}_{0}} \qquad ( 25 )$$

$${t}_{2 y}^{′} = \frac{- u sin {θ}_{0} + w cos {θ}_{0}}{{L}_{2 m} - u cos {θ}_{0} - w sin {θ}_{0}} \qquad ( 26 )$$

As can be found from Formula (22), it can be confirmed that an equation having good symmetry with respect to the light collection in the sagittal direction and the light collection in the meridional direction has been obtained. Although “L₁ₛ>L₁ₘ>0) and L₂ₛ>L₂ₘ>0” are assumed in the derivation described above, the same equation (design formula) provided in Formula (22) is derived even without the assumption described above, that is, even if a magnitude relationship is reversed or each set value takes a negative value. However, all of the four constants L₁ₘ, L₁ₛ, L₂ₘ, and L₂ₛ are positive or negative values and cannot be set to 0.

### (Examples of Mirrors That Can Be Designed)

In condition setting of Formula (22), the values of L₁ₛ and L₁ₘ are set to different values, and the values of L₂ₛ and L₂ₘ are set to be equal to each other (the same value), so that it is possible to design an astigmatism control mirror including a reflecting surface in which an outgoing beam collected on one point can be obtained from an incoming beam having astigmatism. Conversely, by setting the values of L₁ₛ and L₁ₘ to the same value and setting the values of L₂ₛ and L₂ₘ to different values, it is possible to design an astigmatism control mirror including a reflecting surface in which an outgoing beam having astigmatism is obtained from an incoming beam diverging from one point. In addition, by setting the values of L₁ₘ and L₂ₘ to positive or negative infinity and setting L₁ₛ and L₂ₛ to predetermined values (where L₁ₛ+L₂ₛ≠0), an astigmatism control mirror having collection performance only in the sagittal direction can be designed.

In addition, by using the design formula (22), it is also possible to design a mirror including a reflecting surface in which light source/light collection positions of both the light collection in the sagittal direction and the light collection in the meridional direction coincide with each other. For example, by substituting L₁ₛ=L₁ₘ=L₁ and L₂ₛ=L₂ₘ=L₂ into the design formula (22), the following formula (27) is obtained.

$$\begin{matrix}[ Math . 18 ] & \\ f ( u , v , w ) = ( {L}_{1} + {z}_{1} ) \sqrt{1 + {t}_{1 x}^{′2} + {t}_{1 y}^{′2}} + ( {L}_{2} - {z}_{2} ) \sqrt{1 + {t}_{2 x}^{′2} + {t}_{2 y}^{′2}} - ( {L}_{1} + {L}_{2} ) = 0 & ( 27 )\end{matrix}$$

A reflecting surface designed by the formula (27) has any shape of a spheroid, a hyperboloid of revolution, a paraboloid of revolution, or a flat surface depending on the positive/negative and magnitude relationship between L₁ and L₂. The classification thereof is illustrated in Table 1. It should be particularly noted that not only a concave mirror but also a convex mirror and a flat surface are designed with the same formula.

TABLE 1
Classification of Shapes Derived from Design Formulas
of Astigmatism Control Flat Plate Mirror

| Conditions | Shapes |
|---|---|
| L₂ > 0 ∩ L₁ > 0 | Concave spheroid |
| L₂ < 0 ∩ L₁ < 0 | Convex spheroid |
| −L₁ > L₂ > 0 ∪ −L₂ > L₁ > 0 | Concave hyperboloid of |
| | revolution |
| L₂ > −L₁ > 0 ∪ L₁ > −L₂ > 0 | Convex hyperboloid of |
| | revolution |
| (L₁ = ±∞ ∩ L₂ > 0) ∪ (L₁ > 0 ∩ L₂ = ±∞) | Concave paraboloid of |
| | revolution |
| (L₁ = ±∞ ∩ L₂ < 0) ∪ (L₁ < 0 ∩ L₂ = ±∞) | Convex paraboloid of |
| | revolution |
| −L₁ = L₂ ∪ L₁ = L₂ = ±∞ | Flat surface |

When the light collection action of the mirror is limited to the meridional direction, that is, when L₁ₛ=+∞ and L₁ₛ=+∞, Formula (22) is simplified to the following formula (28).

$$\begin{matrix}[ Math . 19 ] & \\ f ( u , v , w ) = ( {L}_{1 m} + {z}_{1} ) \sqrt{1 + {t}_{1 y}^{′2}} + ( {L}_{2 m} - {z}_{2} ) \sqrt{1 + {t}_{2 y}^{′2}} - ( {L}_{1 m} + {L}_{2 m} ) = 0 & ( 28 )\end{matrix}$$

Formula (28) represents an elliptical, parabolic, hyperbolic or linear columnar body. Similarly to Formula (27), different shapes such as a concave surface, a flat surface, and a convex surface are expressed by the positive/negative or magnitude relationship between L₁ₘ and L₂ₘ.

As described above, it can be found that the design formula of the astigmatism control flat mirror according to the present invention is a highly versatile (widely applicable) design formula including the existing mirror such as a spheroidal mirror, a hyperboloid mirror, a paraboloid mirror, a one-dimensional elliptical mirror (one of K-B mirrors), a one-dimensional hyperboloid mirror. a one-dimensional paraboloid mirror, and a flat mirror.

Although the embodiments of the present invention have been described above, it is needless to say that the present invention is not limited to such examples and can be implemented in various forms without departing from the gist of the present invention. In the embodiment, the light source ray and the collected light ray are each a straight line, and the distance between the straight line and the equiphase plane in the vicinity thereof is compensated, but such compensation is not necessarily required. In addition, it is also preferable to obtain an arc line or another curve as the light source ray or the collected light ray without compensation or by a compensation method other than the compensation described above, or by an approximation method. The position of the origin of the design formulae of the reflecting surface may also be set at a different position. It is needless to say that the coordinate transformation may be performed.

### EXAMPLES

Next, as a design example of the astigmatism control mirror according to the present invention described above, four mirrors including two mirrors (Examples 1 and 2) intended to eliminate astigmatism, a mirror (Example 3) intended to add astigmatism, and a mirror (Example 4) intended to collect light only in the sagittal direction are designed, and a result of checking the performance of each mirror by simulation using both geometric optics and wave optics, and a result of comparing the mirror of Example 1 with a conventional mirror will be described.

### (Simulation Technique)

A mirror was set to reflect a beam vertically upward. Specifically, the longitudinal (meridional) direction of the mirror (reflecting surface) corresponds to vertical light collection, and the transverse (sagittal) direction thereof corresponds to horizontal light collection. In light ray tracing calculation based on geometric optics, a light ray group passing through the light source ray for each of the light collections in the meridional direction and the sagittal direction illustrated in FIGS. 1 to 3 is defined and is incident to the reflecting surface of the mirror. In this case, a thickness of the light source ray, i.e., a size of the light source is set to 0. Light rays are uniformly emitted to an entire effective range of the reflecting surface.

A normal vector n(x, y, z) at each position on the reflecting surface of the mirror can be obtained as a numerical solution that is a unit vector parallel to a gradient vector, from a gradient vector of a function f(u, v, w) defined by Formula (22) (Formula (29)). As illustrated in FIG. 1, the incoming light ray is reflected symmetrically about the normal vector of the reflecting surface of the mirror and propagates to the light collecting surface. In this way, variations of the light rays on the light collecting surface are evaluated.

[Math. 20]

n(u,v,w)∥∇f(u,v,w) (29)

In the diffraction integral calculation based on wave optics, lattice points are first arranged at equal intervals in a u direction and a v direction on the reflecting surface of the mirror, and then the coordinates M(u, v, w) of respective points are converted into a coordinate system M(x₁, y₁, z₁) based on the incoming optical axis on the basis of Formula (2). Subsequently, centers of curvature in the x₁ and y₁ directions of the wavefront of the beam incident on the reflecting surface of the mirror are matched with the light source Sₛ of the sagittal direction light collection and the light source Sₘ of the meridional direction light collection, respectively. A line light source having no thickness is assumed, and beams are incident on the entire effective area of the reflecting surface with uniform intensity. A wave motion field U_{M}(x₁, y₁, z₁) at the point M(x₁, y₁, z₁) on the mirror, which is expressed in the X₁y₁z₁ coordinate system, is expressed by the following formulas (30) and (31).

$$\begin{matrix}[ Math . 21 ] & \\ {U}_{M} ( {x}_{1} , {y}_{1} , {z}_{1} ) = {I}_{0} exp ( \frac{2 π j}{λ} {r}_{i} ( {x}_{1} , {y}_{1} , {z}_{1} ) ) & ( 30 )\end{matrix}$$

$${r}_{i} ( {x}_{1} , {y}_{1} , {z}_{1} ) = {z}_{1} + ( {z}_{1} + {L}_{1 s} ) ( \sqrt{1 + {( \frac{{x}_{1}}{{z}_{1} + {L}_{1 s}} )}^{2}} - 1 ) + ( {z}_{1} + {L}_{1 m} ) ( \sqrt{1 + {( \frac{{y}_{i}}{{z}_{1} + {L}_{1 m}} )}^{2}} - 1 ) \qquad ( 31 )$$

In Formula (30), λ represents any constant indicating a wavelength of a beam, and I₀ represents any constant indicating the incoming intensity. A complex wave field U_{M}(x₁, y₁, z₁) on the reflecting surface of the mirror, which is expressed in the X₁y₁z₁ coordinate system, is converted into the x₂y₂z₂ coordinate system as in Formula (32) and expressed as U_{M}(x₂, y₂, z₂).

[Math. 22]

(x₂,y₂,z₂)=(x₁,y₁ cos 2θ₀,y₁ sin 2θ₀+z₁ cos 2θ₀) (32)

Further, a wave motion field U_{M}(x₂, y₂, z₂) is propagated to a point Q(x_{Q}, y_{Q}, z_{Q}) on the light collecting surface defined in the x₂y₂z₂ coordinate system, according to Formulas (33) and (34).

$$\begin{matrix}[ Math . 23 ] & \\ {U}_{Q} ( {x}_{Q} , {y}_{Q} , {z}_{Q} ) = \frac{1}{j λ} \int \frac{{U}_{M} ( {x}_{2} , {y}_{2} , {z}_{2} ) exp ( \frac{2 π j}{λ} {r}_{MQ} )}{{r}_{MQ}} sin θ ( {x}_{2} , {y}_{2} , {z}_{2} ) dS & ( 33 )\end{matrix}$$

$${r}_{MQ} = \sqrt{{( {x}_{Q} - {x}_{2} )}^{2} + {( {y}_{Q} - {y}_{2} )}^{2} + {( {z}_{Q} - {z}_{2} )}^{2}} \qquad ( 34 )$$

In Formula (33), dS represents a minute area on the reflecting surface, and θ(x₂, y₂, z₂) represents an oblique incoming angle at each position on the reflecting surface. What is output is an intensity distribution that is the square of the absolute value of a complex wave field U_{Q}(x_{Q}, y_{Q}, z_{Q}) on Q (Formula (35)). By a procedure described above, the intensity distribution on the light collecting surface is calculated based on wave optics.

[Math. 24]

I_{Q}(x_{Q},y_{Q},z_{Q})=[U_{Q}(x_{Q},y_{Q},z_{Q})]² (35)

### (Mirror Design of Example 1)

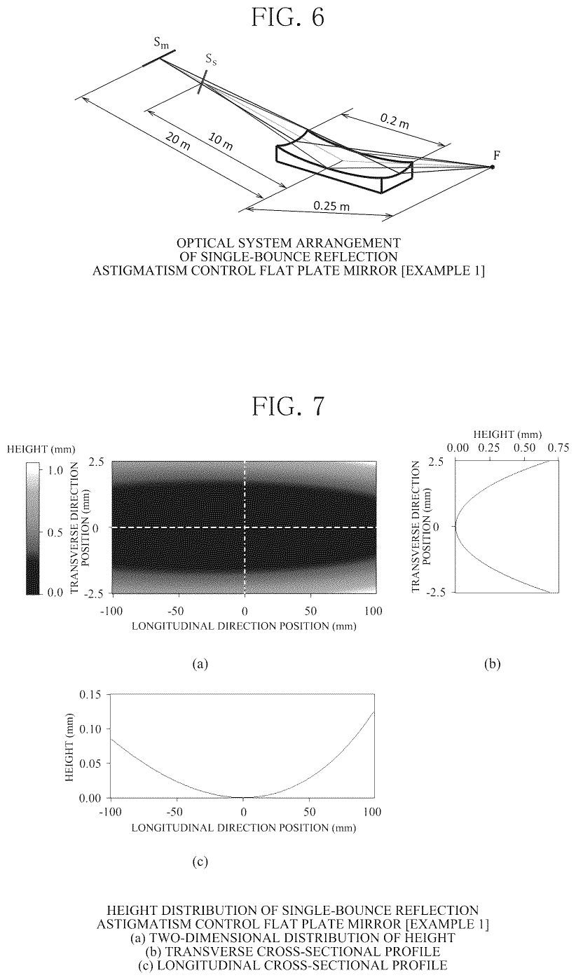

Table 2 illustrates a list of constants used in the mirror design of Example 1. The incoming length has positive values different between the vertical and horizontal directions, and the outgoing length has the same positive value in both the vertical and horizontal directions. FIG. 6 illustrates a schematic diagram of the optical system arrangement.

TABLE 2
Design Conditions of Single-Bounce Reflection
Astigmatism Flat Plate Mirror [Example 1]

| Items | Value |
|---|---|
| Incoming length L₁ₘ of vertical (meridional) light | 20,000 |
| collection (mm) | |
| Outgoing length L₂ₘ of vertical (meridional) light | 250 |
| collection (mm) | |
| Incoming length L₁ₛ of horizontal (sagittal) light | 10,000 |
| collection (mm) | |
| Outgoing length L₂ₛ of horizontal (sagittal) light | 250 |
| collection (mm) | |
| Glancing angle θ₀ (mrad) | 10 |
| Weighting coefficient α | 0.5 |
| Entire length ML (mm) | 200 |
| Entire mirror width MW (mm) | 5 |

(Shape of Reflecting Surface of Example 1)

FIG. 7 illustrates the calculated shape of the reflecting surface of the mirror. FIG. 7(a) illustrates a distribution of a height w(u, v) with respect to the mirror origin when the horizontal axis is set to the u coordinate and the vertical axis is set to the v coordinate. In addition, FIG. 7(b) illustrates a transverse cross-sectional profile indicated by a one-dot chain line in FIG. 7(a), and similarly FIG. 7(c) illustrates a longitudinal cross-sectional profile indicated by a broken line in FIG. 7(a). The reflecting surface of the mirror of Example 1 is a concave surface having different curvatures between the longitudinal direction and the transverse direction.

### (Simulation Result of Light Collection Performance of Example 1)

FIG. 8 illustrates a simulation result of the light collection performance. FIG. 8(a) illustrates a result of calculating variations of light rays on the light collecting surface on the basis of geometric optics. It was confirmed that all the light rays were concentrated in a region of 10 nm or less in both the horizontal and vertical directions.

In addition, FIG. 8(b) illustrates an intensity distribution on the light collecting surface, which is calculated based on wave optics by assuming a soft X-ray of 300 eV. The beams are collected in a region of 160 nm×440 nm (FWHM) in the horizontal and vertical directions, respectively. Since the numerical aperture in the horizontal direction was large, a spot size of a collected beam was further reduced.

### (Mirror Design of Example 2)

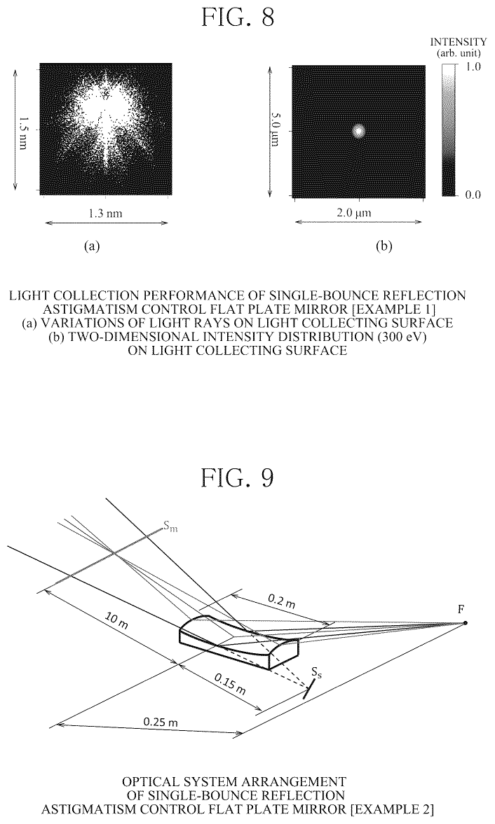

Table 3 illustrates a list of constants used in the mirror design of Example 2. The vertical (meridional) light collection incoming length has a positive value, whereas the horizontal (sagittal) light collection incoming length has a negative value. In other words, the incoming beam has a property to have a light source point located upstream of the mirror in the vertical direction and be collected toward one point located downstream of the mirror in the horizontal direction. The outgoing length has the same positive value in both the vertical direction and the horizontal direction. FIG. 9 illustrates a schematic diagram of the optical system arrangement. This mirror is intended to eliminate extreme astigmatism in which the positive and negative curvatures are inverted.

TABLE 3
Design Conditions of Single-Bounce Reflection
Astigmatism Flat Plate Mirror [Example 2]

| Items | Value |
|---|---|
| Incoming length L₁ₘ of vertical (meridional) light | 10,000 |
| collection (mm) | |
| Outgoing length L₂ₘ of vertical (meridional) light | 250 |
| collection (mm) | |
| Incoming length L₁ₛ of horizontal (sagittal) light | −150 |
| collection (mm) | |
| Outgoing length L₂ₛ of horizontal (sagittal) light | 250 |
| collection (mm) | |
| Glancing angle θ₀ (mrad) | 10 |
| Weighting coefficient α | 0.5 |
| Entire length ML (mm) | 200 |
| Entire mirror width MW (mm) | 5 |

### (Shape of Reflecting Surface of Example 2)

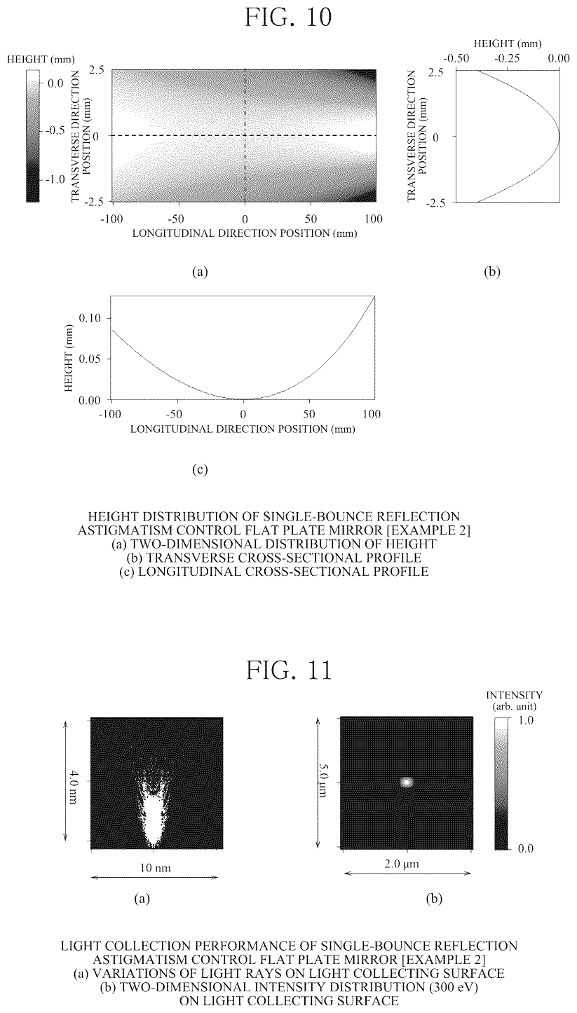

FIG. 10 illustrates the calculated shape of the reflecting surface of the mirror. FIG. 10(a) illustrates a distribution of a height w(u, v) with respect to the mirror origin when the horizontal axis is set to the u coordinate and the vertical axis is set to the v coordinate. In addition, FIG. 10(b) illustrates a transverse cross-sectional profile taken along a one-dot chain line in FIG. 10(a), and similarly FIG. 10(c) illustrates a longitudinal cross-sectional profile taken along a broken line in FIG. 10(a). The reflecting surface of the mirror of Example 2 has a saddle shape having a concave profile in the longitudinal direction and a convex profile in the transverse direction.

### (Simulation Result of Light Collection Performance of Example 2)

FIG. 11 illustrates a simulation result of the light collection performance. FIG. 11(a) illustrates a result of calculating variations of light rays on the light collecting surface on the basis of geometric optics. It was confirmed that all the light rays were concentrated in a region of 10 nm or less in both the horizontal and vertical directions.

In addition, FIG. 11(b) illustrates an intensity distribution on the light collecting surface, which is calculated based on assuming a soft X-ray of 300 eV. The beams are collected in a region of 160 nm×320 nm (FWHM) in the horizontal and vertical directions, respectively. Consequently, it was shown in the simulation that the aberration of the incoming beam having the extreme astigmatism in which one side thereof is collected and the other side diverges can be eliminated by the mirror of Example 2.

### (Mirror Design of Example 3)

Table 4 illustrates a list of constants used in the mirror design of Example 3. The incoming length has the same positive value in both the vertical and horizontal directions, and the outgoing length has different positive values between the vertical and horizontal directions. FIG. 12 illustrates a schematic diagram of the optical system arrangement.

TABLE 4
Design Conditions of Single-Bounce Reflection
Astigmatism Flat Plate Mirror [Example 3]

| Items | Value |
|---|---|
| Incoming length L₁ₘ of vertical (meridional) light | 10,000 |
| collection (mm) | |
| Outgoing length L₂ₘ of vertical (meridional) light | 20,000 |
| collection (mm) | |
| Incoming length L₁ₛ of horizontal (sagittal) light | 10,000 |
| collection (mm) | |
| Outgoing length L₂ₛ of horizontal (sagittal) light | 10,000 |
| collection (mm) | |
| Glancing angle θ₀ (mrad) | 10 |
| Weighting coefficient α | 0.5 |
| Entire length ML (mm) | 200 |
| Entire mirror width MW (mm) | 5 |

### (Shape of Reflecting Surface of Example 3)

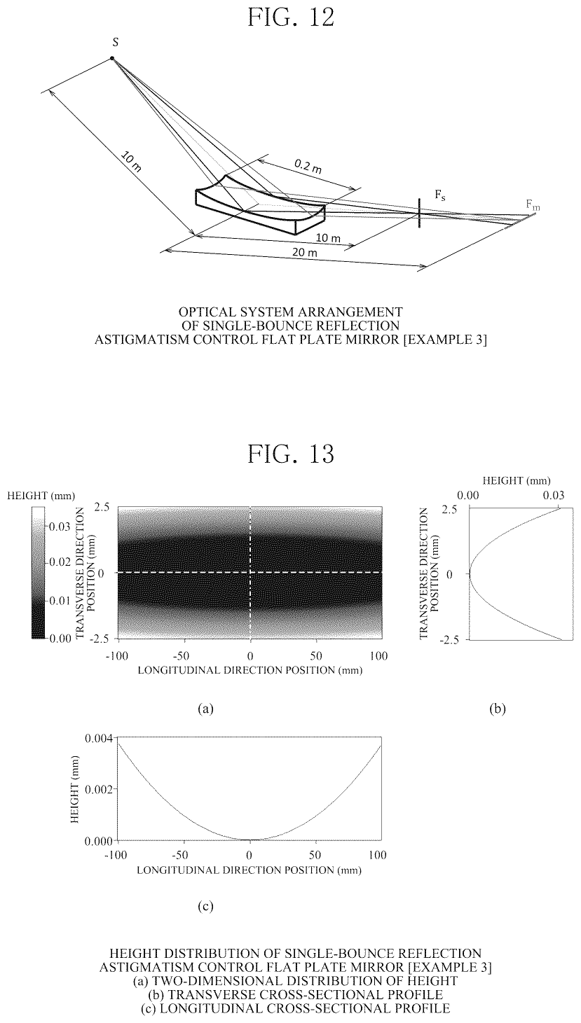

FIG. 13 illustrates the calculated shape of the reflecting surface of the mirror. FIG. 13(a) illustrates a distribution of a height w(u, v) with respect to the mirror origin when the horizontal axis is set to the u coordinate and the vertical axis is set to the v coordinate. In addition, FIG. 13(b) illustrates a transverse cross-sectional profile taken along a one-dot chain line in FIG. 13(a), and similarly FIG. 13(c) illustrates a longitudinal cross-sectional profile taken along a broken line in FIG. 13(a). The reflecting surface of the mirror of Example 3 is a concave surface having different curvatures between the longitudinal direction and the transverse direction.

### (Simulation Result of Light Collection Performance of Example 3)

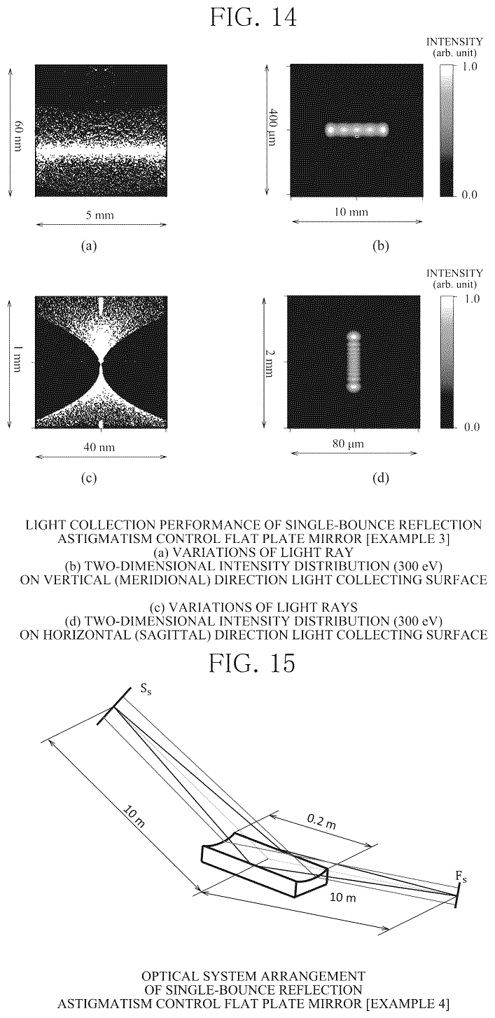

FIG. 14 illustrates a simulation result of the light collection performance. FIG. 14(a) illustrates a result of calculating variations of light rays on the light collecting surface (z₂=L₂ₘ) in the vertical direction on the basis of geometric optics. It was confirmed that all the light rays were concentrated in a region having a width of 60 nm in the vertical direction.

In addition, FIG. 14(b) illustrates an intensity distribution on the light collecting surface in the vertical direction with respect to a soft X-ray beam of 300 eV, the intensity distribution being calculated based on wave optics. The beam is collected within a width of 39 μm (FWHM). Similarly, the light collection performance on light collecting surface (z₂=L₂ₛ) in the horizontal direction was evaluated by simulation. The results are illustrated in FIGS. 14(c) and 14(d). A light collection width of the horizontal light collection was 40 nm in geometric optics and 7.7 μm (FWHM) in wave optics.

### (Mirror Design of Example 4)

Table 5 illustrates a list of constants used in the mirror design of Example 4. Regarding vertical light collection, the incoming length and the outgoing length have positive infinity values. This indicates that the mirror does not have the light collection performance in the meridional direction. On the other hand, both the incoming length and the outgoing length of the horizontal light collection have positive values. FIG. 15 illustrates a schematic diagram of the optical system arrangement.

TABLE 5
Design Conditions of Single-Bounce Reflection
Astigmatism Flat Plate Mirror [Example 4]

| Items | Value |
|---|---|
| Incoming length L₁ₘ of vertical (meridional) light | +∞ |
| collection (mm) | |
| Outgoing length L₂ₘ of vertical (meridional) light | +∞ |
| collection (mm) | |
| Incoming length L₁ₛ of horizontal (sagittal) light | 10,000 |
| collection (mm) | |
| Outgoing length L₂ₛ of horizontal (sagittal) light | 1,000 |
| collection (mm) | |
| Glancing angle θ₀ (mrad) | 10 |
| Weighting coefficient α | 0 |
| Entire length ML (mm) | 200 |
| Entire mirror width MW (mm) | 5 |

### (Shape of Reflecting Surface of Example 4)

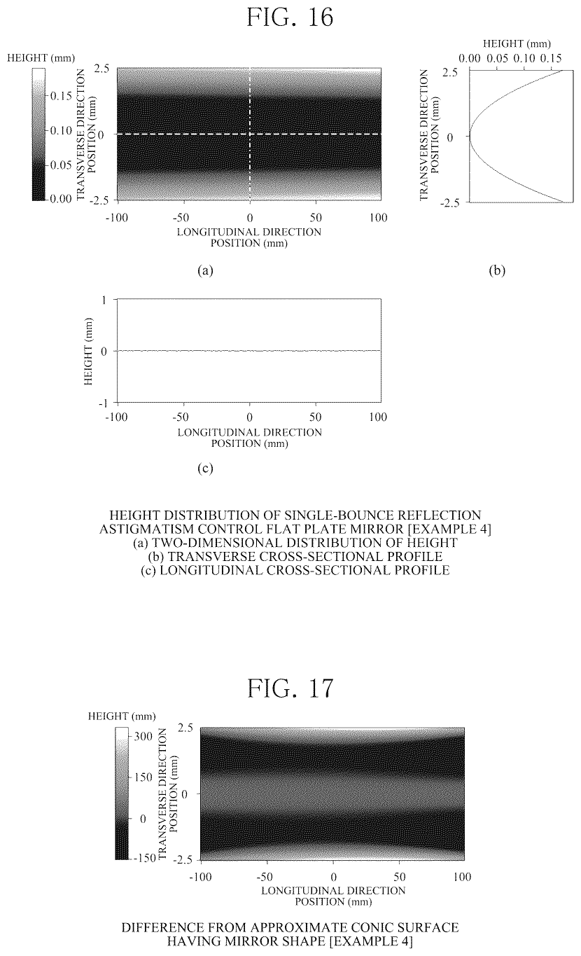

FIG. 16 illustrates the calculated shape of the reflecting surface of the mirror. FIG. 16(a) illustrates a distribution of a height w(u, v) with respect to the mirror origin when the horizontal axis is set to the u coordinate and the vertical axis is set to the v coordinate. In addition, FIG. 16(b) illustrates a transverse cross-sectional profile taken along a one-dot chain line in FIG. 16(a), and similarly FIG. 16(c) illustrates a longitudinal cross-sectional profile taken along a broken line in FIG. 16(a). It can be found from FIG. 16(c) that the reflecting surface of the mirror of Example 4 has a completely linear profile in the longitudinal direction.

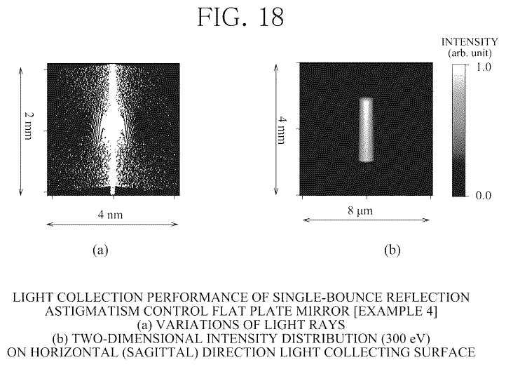

In addition, FIG. 17 illustrates a difference from a truncated cone having a mirror shape. The RMS value of the difference was 77 nm. It can be found that the shape of the mirror having the light collection performance only in the sagittal direction can be fairly approximated by a truncated cone.

### (Simulation Result of Light Collection Performance of Example 4)

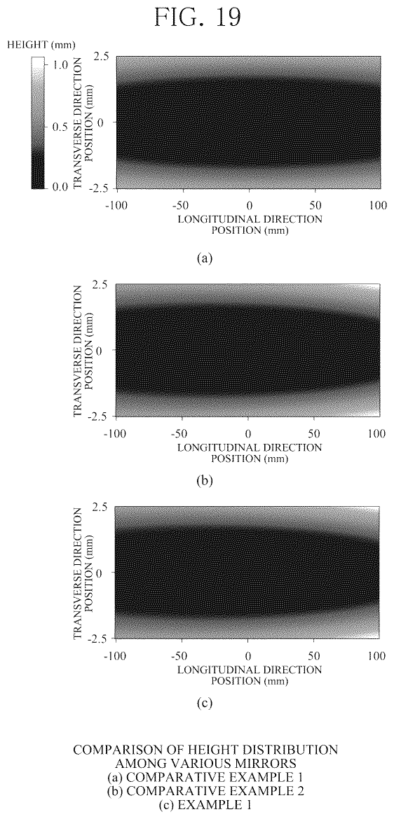

Next, FIG. 18 illustrates a simulation result of the light collection performance. FIG. 18(a) illustrates a result of calculating variations of light rays on the light collecting surface (z₂=L₂ₛ) in the vertical direction on the basis of geometric optics. It was confirmed that all the light rays were concentrated in a region having a width of 10 nm or less.

In addition, FIG. 18(b) illustrates an intensity distribution on the light collecting surface in the vertical direction with respect to a soft X-ray beam of 300 eV, the intensity distribution being calculated based on wave optics. The beam was collected in a region having a width of 770 nm (FWHM).

### (Comparison of Various Mirrors)

Subsequently, comparison is made with existing mirrors such as a toroidal mirror (Comparative Example 1) and an astigmatic off-axis mirror (Comparative Example 2) for the purpose of eliminating astigmatism, which are set in the same conditions as the design conditions of Example 1 illustrated in Table 2.

### (Comparison of Reflecting Surface Shapes)

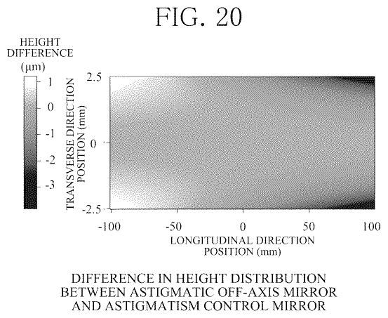

FIG. 19 illustrates the shapes of the reflecting surfaces of the mirrors of Example 1 and Comparative Examples 1 and 2. As can be found from FIGS. 19(b) and 19(c), the mirrors of Comparative Example 2 and Example 1 have substantially the same shape. However, as can be found from FIG. 20 illustrating a result obtained by subtracting the height distribution of the mirror of Example 1 from the height distribution of the mirror of Comparative Example 2, there is a difference in order of μm in the shapes of the mirrors.

### (Comparison of Light Collection Performance)

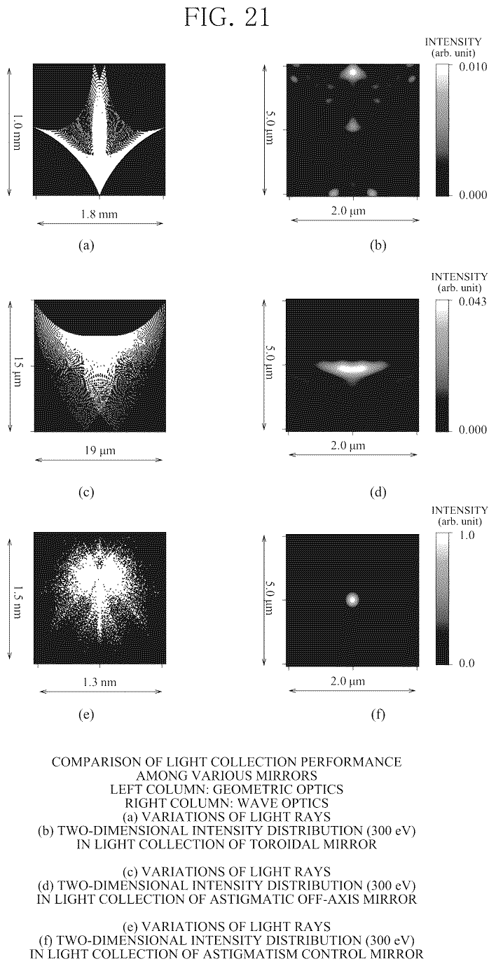

FIG. 21 illustrates a simulation result of the light collection performance. The variations of the light rays illustrated in the left column of FIG. 21 were 2 mm in Comparative Example 1 (toroidal mirror), 20 μm in Comparative Example 2 (astigmatic off-axis mirror), and 2 nm in Example 1 (astigmatism control mirror according to the present invention).

The right column of FIG. 21 illustrates the results of calculating the light collection performance for a soft X-ray beam of 300 eV based on wave optics. The toroidal mirror of Comparative Example 1 no longer collects light. The astigmatic off-axis mirror of Comparative Example 2 collects light, but has a main peak largely spreading in the horizontal direction. The astigmatism control mirror of Example 1 collects light up to the diffraction limit size in both the meridional direction and the sagittal direction. Of the three mirrors, only Example 1 (astigmatism control mirror) enables diffraction-limited light collection in the soft X-ray region.

1. A method for designing a mirror manufactured by forming a reflecting surface on a plate surface, the method comprising:
defining an optical axis of an incoming beam to the mirror as a z₁ axis, and defining a cross section orthogonal to the z₁ axis as an x₁y₁ plane;
defining an optical axis of an outgoing beam from the mirror as a z₂ axis, and defining a cross section orthogonal to the z₂ axis as an x₂y₂ plane;
setting the x₁ axis and the x₂ axis to be parallel to a sagittal direction of the reflecting surface;
causing incoming beams to have a light source for light collection in the sagittal direction at a position displaced by L₁ₛ in a z-axis direction from an intersection point M₀ on the z₁ axis on the reflecting surface between the z₁ axis and the z₂ axis, and a light source for light collection in a meridional direction at a position displaced by L₁ₘ in the z₁-axis direction from the intersection point M₀ on the z₁ axis;
causing outgoing beams to be collected at a position displaced by L₂ₛ in a z₂-axis direction from the intersection point M₀ on the z₂ axis for light collection in a sagittal direction, and to be collected at a position displaced by L₂ₘ in the z₂-axis direction from the intersection point M₀ on the z₂ axis for light collection in a meridional direction;
causing all incoming light rays passing through the mirror to pass through both a sagittal light source ray and a meridional light source ray, the sagittal light source ray passing through a position of the light source in the light collection in the sagittal direction and extending in a direction orthogonal to both the x₁ axis and the z₁ axis, the meridional light source ray passing through a position of the light source in light collection in the meridional direction and extending in a direction orthogonal to both the y₁ axis and the z₁ axis;
causing all outgoing light rays emitted from the mirror to pass through both a sagittal collected light ray and a meridional collected light ray, the sagittal collected light ray passing through a collecting position in the light collection in the sagittal direction and extending in a direction orthogonal to both the x₂ axis and the z₂ axis, the meridional collected light ray passing through a collecting position in the light collection in the meridional direction and extending in a direction orthogonal to both the y₂ axis and the z₂ axis;
representing any point on the reflecting surface of the mirror by M, expressing coordinates of an intersection point between the sagittal light source ray and an incoming light ray to the M point and an intersection point between the meridional light source ray and the incoming light ray to the M point by using the L₁ₛ and the L₁ₘ, and expressing coordinates of an intersection point between an outgoing light ray from the M point and the sagittal collected light ray and an intersection point between the outgoing light ray from the M point and the meridional collected light ray by using the L₂ₛ and the L₂ₘ; and
designing the mirror by using design formulas of the reflecting surface derived based on the coordinates and a condition that an optical path length from a light source position to a light collection position is constant with respect to any point on the reflecting surface for both the light collection in the sagittal direction and the light collection in the meridional direction.

2. The method for designing a mirror according to claim 1, wherein
the sagittal light source ray and the meridional light source ray are defined as a straight line Sₛ extending in a y₁-axis direction and a straight line Sₘ extending in an x₁-axis direction, respectively,
the sagittal collected light ray and the meridional collected light ray are defined as a straight line Fₛ extending in a y₂-axis direction and a straight line Fₘ extending in an x₂-axis direction, respectively,
an incoming length from the light source position to the M point with respect to the light collection in the sagittal direction is obtained as a distance to the M point from an intersection point on a side close to the meridional light source ray Sₘ of two intersection points between the incoming light ray and an equiphase plane A₁ₛ, the equiphase plane A₁ₛ being a rotated arcuate plane obtained by rotating, around the sagittal light source ray Sₛ, an arc that is formed around an intersection point Pₘ₀ between the meridional light source ray Sₘ and the z₁ axis and extends in a direction orthogonal to the x; axis through an intersection point Pₛ₀ between the sagittal light source ray Sₛ and the z₁ axis,
an outgoing length from the M point to the light collection position with respect to the light collection in the sagittal direction is obtained as a distance to the M point from an intersection point on a side close to the meridional collected light ray Fₘ of two intersection points between the outgoing light ray and an equiphase plane A₂ₛ, the equiphase plane A₂ₛ being a rotated arcuate plane obtained by rotating, around the sagittal collected light ray Fₛ, an arc that is formed around an intersection point Qₘ₀ between the meridional collected light ray Fₘ and the z₂ axis and extends in a direction orthogonal to the x₂ axis through an intersection point Qₛ₀) between the sagittal collected light ray Fₛ and the z₂ axis,
an incoming length from the light source position to the M point with respect to the light collection in the meridional direction is obtained as a distance to the M point from an intersection point on a side close to the sagittal light source ray Sₛ of two intersection points between the incoming light ray and an equiphase plane A₁ₘ, the equiphase plane A₁ₘ being a rotated arcuate plane obtained by rotating, around the meridional light source ray Sₘ, an arc that is formed around the intersection point Pₛ₀ between the sagittal light source ray Sₛ and the z₁ axis and extends in a direction orthogonal to the y₁ axis through the intersection point Pₘ₀ between the meridional light source ray Sₘ and the z₁ axis,
an outgoing length from the M point to the light collection position with respect to the light collection in the meridional direction is obtained as a distance to the M point from an intersection point on a side close to the sagittal collected light ray Fₛ of two intersection points between the outgoing light ray and an equiphase plane A₂ₘ, the equiphase plane A₂ₘ being a rotated arcuate plane obtained by rotating, around the meridional collected light ray Fₘ, an arc that is formed around the intersection point Qₛ₀ between the sagittal collected light ray Fₛ and the z₂ axis and extends in a direction orthogonal to the y₂ axis through the intersection point Qₘ₀ between the meridional collected light ray Fₘ and the z₂ axis, and
the optical path length is calculated for the light collection in the sagittal direction and the light collection in the meridional direction.

3. The method for designing a mirror according to claim 2, wherein
the distance to the M point from the intersection point on the side close to the meridional light source ray Sₘ of the two intersection points between the incoming light ray and the equiphase plane A₁ₛ is obtained by obtaining a distance to the M point from an intersection point Pₛ between the incoming light ray and the sagittal light source ray Sₛ, and adding or subtracting, to or from the distance, a distance from the intersection point Pₛ to the arc defining the equiphase plane A₁ₛ,
the distance to the M point from the intersection point on the side close to the meridional collected light ray Fₘ of the two intersection points between the outgoing light ray and the equiphase plane A₂ₛ is obtained by obtaining a distance to the M point from an intersection point Qₛ between the outgoing light ray and the sagittal collected light ray Fₛ, and adding or subtracting, to or from the distance, a distance from the intersection point Qₛ to the arc defining the equiphase plane A₂ₛ,
the distance to the M point from the intersection point on the side close to the sagittal light source ray Sₛ of the two intersection points between the incoming light ray and the equiphase plane A₁ₘ is obtained by obtaining a distance to the M point from an intersection point Pₘ between the incoming light ray and the meridional light source ray Sₘ, and adding or subtracting, to or from the distance, a distance from the intersection point Pₘ to the are defining the equiphase plane A₁ₘ, and
the distance to the M point from the intersection point on the side close to the sagittal collected light ray Fₛ of the two intersection points between the outgoing light ray and the equiphase plane A₂ₘ is obtained by obtaining a distance to the M point from an intersection point Qₘ between the outgoing light ray and the meridional collected light ray Fₘ, and adding or subtracting, to or from the distance, a distance from the intersection point Qₘ to the arc defining the equiphase plane A₂ₘ.

4. The method for designing a mirror according to claim 1, wherein
a plane that includes an intersection point M₀ on the reflecting surface between the z₁ axis and the z₂ axis and is in contact with the reflecting surface is defined as a uv plane,
a direction of a normal line passing through the M₀ in the uv plane is defined as a w axis,
a v axis is a direction orthogonal to both the z₁ axis and the z₂ axis, and a u axis is a direction orthogonal to both the v axis and the w axis,
an orthogonal coordinate system is defined based on a mirror, in which the intersection point Ma is set as an origin, and an oblique incoming angle formed by the uv plane and an optical axis z₁ is represented by θ₀,
the coordinates are transformed into an X₁y₁z₁ coordinate system based on an optical axis of the incoming beam and into an x₂y₂z₂ coordinate system based on an optical axis of the outgoing beam, respectively, and
a design formula is expressed by a uvw coordinate system.

5. The method for designing a mirror according to claim 4, wherein the design formula is obtained from a following formula (1) obtained by weighting both a first formula fₛ(u, v, w)=0 derived from a condition that an optical path length from a light source point to a light collection point is constant for the light collection in the sagittal direction, and a second formula fₘ(u, v, w)=0 derived from a condition that an optical path length from the light source point to the light collection point is constant for the light collection in the meridional direction.
[Math. 1]
f(u,v,w)=αfₛ(u,v,w)+βfₘ(u,v,w)=0
0≤α≤1, β=1−α (1)

6. An astigmatism control mirror having a reflecting surface satisfying the design formula according to claim 1, wherein
values of the L₁ₛ and the L₁ₘ are different from each other, and values of the L₂ₛ and the L₂ₘ are equal to each other, and
outgoing beams which are collected at one point are obtained from an incoming beam having astigmatism.

7. An astigmatism control mirror having a reflecting surface satisfying the design formula according to claim 1, wherein
values of the L₁ₛ and the L₁ₘ are equal to each other, and values of the L₂ₛ and the L₂ₘ are different from each other, and
an outgoing beam having astigmatism is obtained from an incoming beam diverging from one point.

8. An astigmatism control mirror having a reflecting surface satisfying the design formula according to claim 1, wherein
values of the L₁ₘ and the L₂ₘ are positive or negative infinity, and each of the L₁ₛ and the L₂ₛ has a predetermined value (where L₁ₛ+L₂≠0), and
the astigmatism control mirror has light collection performance only in the sagittal direction.
